(19) United States
(12) Patent Application Publication
(10) Pub. No.: US 2014/0137448 A1
(43) Pub. Date: May 22, 2014

(54) Temporary Vehicle Door Display Device

(71) Applicant: Lori Reiter, Bellevue, WA (US)

(72) Inventor: Lori Reiter, Bellevue, WA (US)

(21) Appl. No.: 14/082,936

(22) Filed: Nov. 18, 2013

Related U.S. Application Data
(60) Provisional application No. 61/727,611, filed on Nov. 16, 2012.

(51) Int. Cl. G09F 21/04; G09F 7/18

(52) U.S. Cl. CPC G09F 21/048; G09F 7/18
USPC 40/591

(57) ABSTRACT

An inexpensive temporary vehicle door display device with a planar member with indicia such as a visual symbol, message or advertisement printed thereon, that includes an integrally formed edge member along a vertical edge that selectively attaches to the trailing edge of a vehicle door. The edge member has a door edge cavity that receives the trailing edge of the vehicle door when the device is installed. The planar member is made of thin flexible material designed to extend over and at least partially cover the outside surface of the door. The planar member may be color-coded to match the color of the door and includes at least one magnetic element attached to the inside surface of the planar member that holds the planar member over the exterior surface of the door. Printed on the planar member are indicia such as words, letters, numbers, images, advertisements or promotional materials.

This utility patent application is based upon and claims the filing date benefit of U.S. provisional patent application (Application No. 61/727,611) filed on Nov. 16, 2012.

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present disclosure relates to magnetic displays or signs that temporarily attach to a vehicle door that resists removal when the vehicle is parked.

2. Description of the Related Art

Magnetic door displays or signs for a motor vehicle that advertise a service or product or shows the vehicle owner's support to a particular sports team or event are well known. Unfortunately, because the display or sign is only attached to the outside surface of the door, it can be easily detached. Displays or signs showing support of a sports team or a politician are very popular and vulnerable to be stolen. To prevent thefts, vehicle owners often remove the display or sign from the door when the vehicle is parked.

What is needed is a temporary motor vehicle display or sign that is relatively inexpensive that can be easily attached to the outside surface of a door that resists removal when the vehicle is parked.

### SUMMARY OF THE INVENTION

An inexpensive, temporary motor vehicle display device, that resists removal from the door when the motor vehicle is parked.

The device includes a thin, flexible planar member with an elongated edge member formed or attached to one end. The edge member is perpendicularly aligned with the planar member's longitudinal axis and includes a door edge cavity configured to receive the vertical edge of a vehicle door. The planar member which extends laterally over the outside surface of the door includes a magnetic element attached to its inside surface with sufficient magnetic attracting force to tightly hold the planar member in place. In the preferred embodiment, the device is made of molded material so that the planar member and the edge member are integrally formed and form a single structure. The edge member is made of resilient material and includes a u-shaped cross-sectional profile that defines a door edge cavity that receives the door edge. The edge member is also sufficiently flexible to bend and conform to trailing edges on the doors used on different makes and models of motor vehicles. The planar member may also be color coded to match the color of the door.

Printed or attached to the outside surface of the planar member is indicia, such as single or multiple words, letters, numbers, images which may be used as advertisements or promotional communications.

The combination of a planar member, an edge member and a magnetic sheet makes the device difficult to remove when the door is closed and thereby unlikely to be removed by an individual walking by the door.

Using the above described device, a method of displaying indicia on the outside surface of a vehicle door and protecting the outside surface of the vehicle door and also resists removal when the door is closed.

### DESCRIPTION OF THE DRAWINGS

FIG. 1 is a side view of a temporary vehicle door display device, installed on a door of a motor vehicle.

FIG. 2 is a partial cross-sectional view of the device.

FIG. 3 is a side view of the device showing an animal printed on the outer surface of the planar member.

FIG. 4 is a side view of the device showing a football helmet printed on the outer surface of the planar member.

FIG. 5 is a side elevational view of the device.

FIG. 6 is an end elevational view of device shown in FIG. 5.

### DESCRIPTION OF THE PREFERRED EMBODIMENT(S)

In the following description, certain specific details are set forth in order to provide a thorough understanding of various disclosed embodiments. However, one of ordinary skill in the relevant art will recognize that embodiments may be practiced without one or more of these specific details. In other instances, well-known structures associated with door edge guards may not be shown or described in detail to avoid unnecessarily obscuring descriptions of the embodiments.

Unless the context requires otherwise, throughout the specification and claims which follow, the word “comprise” and variations thereof, such as, “comprises” and “comprising” be construed in an open, inclusive sense, that is as “including, but not limited to.”

Reference throughout this specification to “one embodiment” or “an embodiment” means that a particular feature, structure or characteristic described in connection with the embodiment is included in at least one embodiment. The appearances of the phrases “in one embodiment” or “in an embodiment” in various places throughout this specification are not necessarily all referring to the same embodiment. The features, structures, or characteristics may be combined in any suitable manner in one or more embodiments.

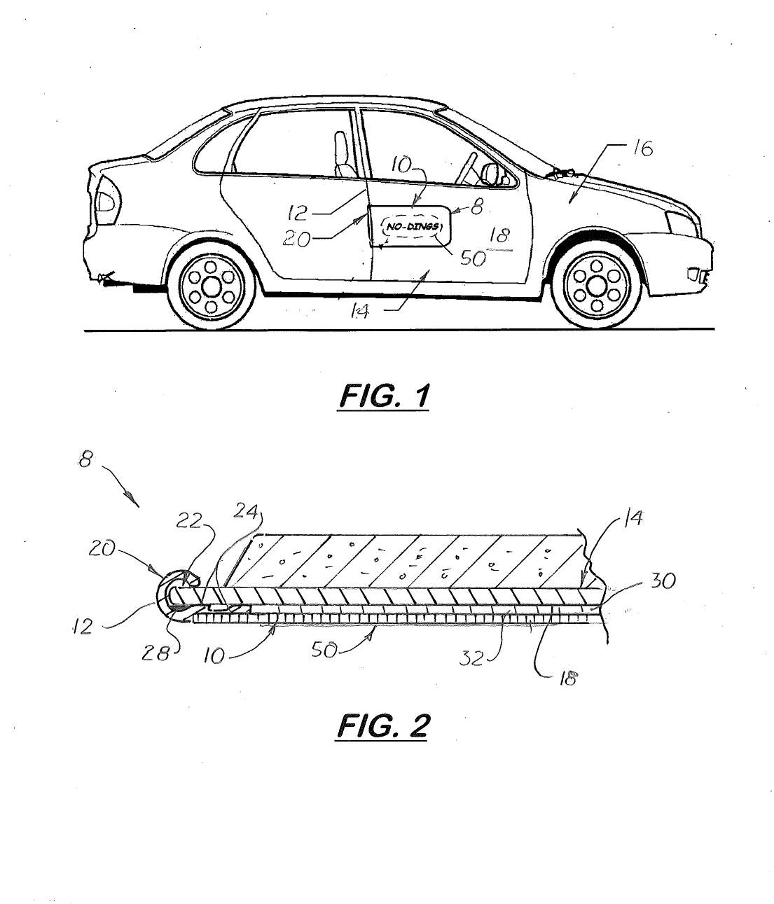

FIGS. 1 and 2 show an inexpensive, easy to install, temporary vehicle door display device 8 that allows an operator of a vehicle 16 to display desirable indicia 50 on one of the motor vehicle's door 14. The device 8 includes a thin, flexible planar member 10 designed to extend across the outside surface of the door 14. Formed or attached to the planar member 10 is an elongated edge member 20 designed to slide onto and grip the edge of the door 14. In the embodiments shown herein, the device 8 is shown attached to the trailing edge 12 of a door 14 of a vehicle 16 to protect the trailing edge 12 and objects that the door edge 12 may contact with when opening the door 14.

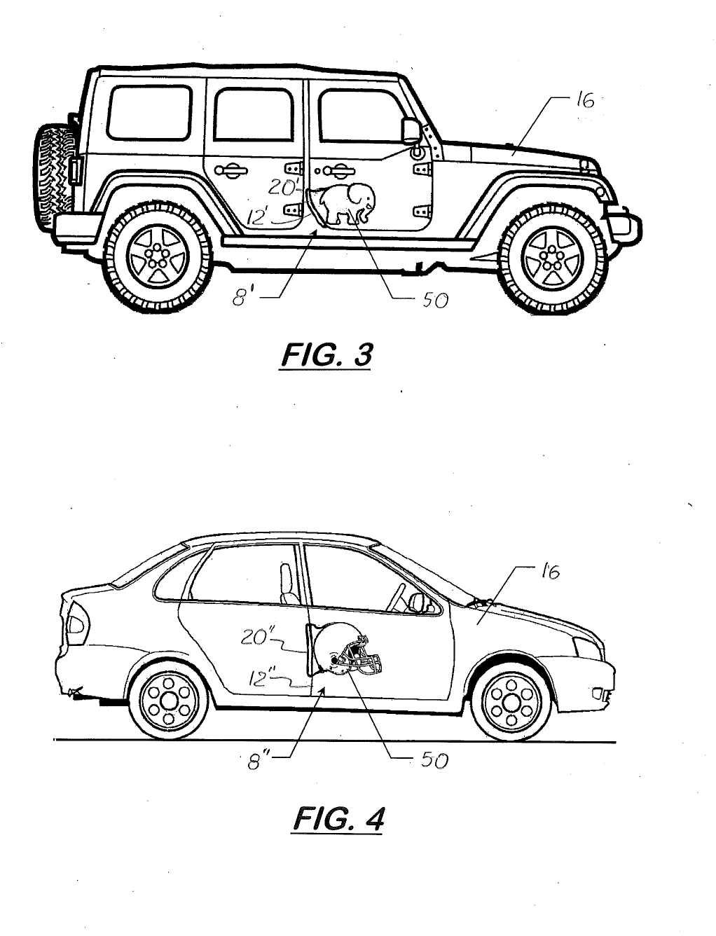

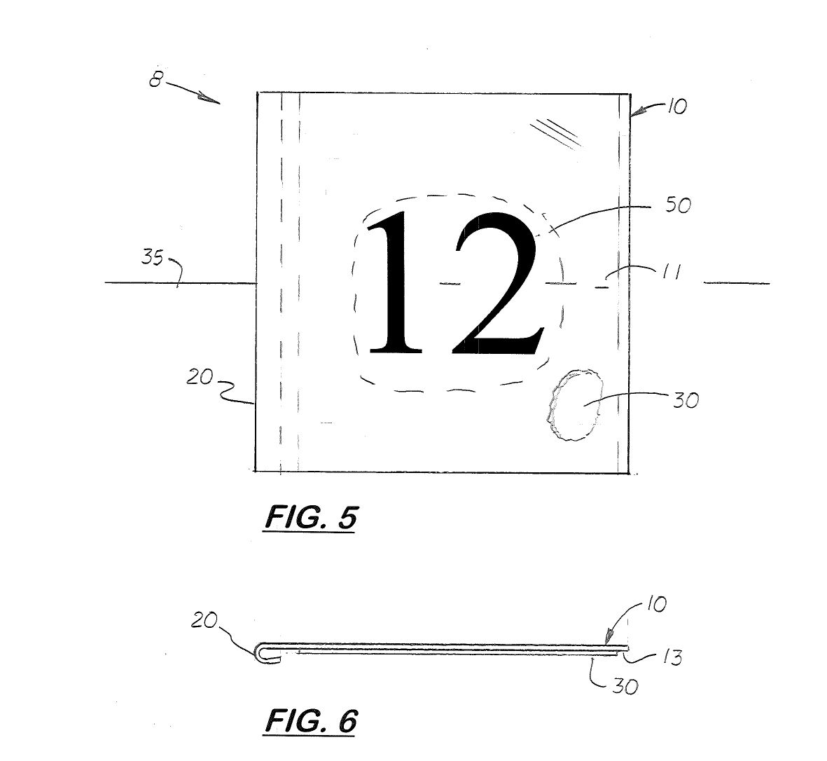

The edge member 20 is an elongated gutter-like structure with a door edge cavity 22 formed therein, as shown in FIG. 2. As stated above, the elongated edge member 20 is configured to slide over and receive the door edge 12 of the vehicle door 14 when the device 8 is installed. The edge member 20 may be made of a flexible, resilient material and formed to include a u-shaped cross-sectional profile sized to receive and grip the door edge 12 in a friction fit. In some embodiments, the edge member 20 may include barbs or other gripping features 24 to assist in gripping the door edge 12 or door surface 14. In some embodiments, the edge member 20 may also include optional magnetic strips 28 to assist in maintaining the edge member 20 in place on the door edge 12. The edge member 20 may be elongated and may be flexible to accommodate non-linear door edges 12 (see FIGS. 3-4). In some embodiments, however, the edge member 20 may be formed to include a curved or non-linear profile that corresponds to the profile of the door edge 12 of a particular make and model of a desired host vehicle 16. Although the edge member 20 is shown as comprising an integral body, in other embodiments, the edge member 20 may be formed of one or more layers or components. In the preferred embodiment, the edge member 20 is the same length as the length of the planar member 10.

The planar member 10 is made of thin, flexible material, such as rubber, silicone or vinyl approximately 15 to 50 mils thick. The planar member 10 may be square, rectangular, triangular, circular, or oval. The planar member 10 may be 6 to 24 inches in width and 6 to 24 inches in length. Attached to the inside surface of the planar member 10 is one or more magnetic elements 30 which may be a single magnetic sheet, or one or more magnetic strips or squares. In the preferred embodiment, the magnetic element 30 is hidden behind the planar member 10 and not visible when attached to the vehicle door 14. The magnetic element 30 may be adhesively attached to the inside surface of the planar member 10. As shown in FIG. 1, the magnetic element 30 may extend from the edge member 20 along substantially the entire height of the edge member 20 and in a horizontal direction to form a rectangular outer profile. The magnetic element 30 may extend a few inches from the edge member 20 or may extend across a substantial portion of the door 16. In some embodiments, the magnetic element 30 may extend horizontally across at least twenty percent of an overall width of the vehicle door 16. The magnetic element 30 may extend a few inches in a vertical direction or may extend vertically over a substantial portion of the door 16. When the device 8 is installed, the portion of the exterior surface 18 of the vehicle door 14 covered may include a region immediately adjacent to the trailing edge 12.

With continued reference to FIGS. 1 and 2, the planar member 10 may be integrally formed with the edge member 20. The magnetic element 30 is advantageously attracted to metallic door surfaces 18 to assist in securing the device 8 in place on the door 14. The magnetic element 30 extends from the edge member 20 to provide protection for other areas of the door 14 apart from the edge 12.

The planar member 10 provides a surface with which to advertise or promote goods and services or to display other images or messages are printed or attached. The images, advertisements and/or promotional materials may be coated or otherwise covered with one or more additional layers, such as a transparent protection layer.

FIGS. 3 and 4 show other embodiments of a device 8′, 8″ showing the edge member 20′, 20″ conforming to a non-linear door edge 12′ 12″.

In addition, a method of displaying indicia on the outside surface of a vehicle door 14 and protecting the outside surface of the vehicle door 14 is also disclosed, comprising the following steps:

a. installing a holder with a planar member 10 and an integrally formed an edge member 20, 20′, 20″ configured to engage the edge 12, 12′, 12″ of a vehicle door 14, with at least one magnetic element 30 embedded or attached to the planar member 10 and magnetically holds the planar member 10 on an exterior surface 18 of a vehicle door 14 when the edge member 20, 20′, 20″ is attached to the edge 12, 12′, 12″ of a vehicle door 14, said planar member 10 includes indicia 50 printed or formed thereon;

b. selecting a door 14 with an exposed door edge to attach said device 8;

c. aligning said device 8 so that said indicia 50 faces outward and visible; and,

d. attaching said edge member 20, 20′, 20″ to said door edge 12 and position said magnetic element 30 against the exterior surface 18 of the vehicle door 14.

The various embodiments described above can be combined to provide further embodiments. These and other changes can be made to the embodiments in light of the above-detailed description. In the following claims, the terms used should not be construed to limit the claims to the specific embodiments disclosed in the specification and the claims, but should be construed to include all possible embodiments with the full scope of equivalents to which such claims are entitled.

I claim:

1. A temporary vehicle door display device, comprising:
a flexible planar member having an inside surface and an outside surface;
an edge member integrally formed along one edge of said planar member, said edge member including a door edge cavity configured to receive a edge of a vehicle door when said planar member is disposed over the outside surface of the door;
at least one magnetic element attached or coupled to said inside surface of said planar member; and,
indicia printed or attached to said outside surface of said planar member.

2. The device of claim 1, wherein said edge member is u-shaped cross-sectional profile.

3. The device of claim 1, wherein said planar member has longitudinal access and said edge member is perpendicularly aligned therewith.

4. The device of claim 1, wherein the planar member is made of rubber, silicone or vinyl and 15 to 50 mils think.

5. The device of claim 1, wherein the edge member is formed to include a profile that reflects a profile of the trailing edge of a vehicle door.

6. The device of claim 1, wherein the magnetic element is a magnetic planar sheet.

7. The device of claim 1, wherein the magnetic element is a magnetic strip.

8. The device of claim 1, wherein the magnetic elements are invisible when said device is attached to outside surface of the vehicle door.

9. The device of claim 1, wherein said outside surface of planar element matches the color of the vehicle door.

10. A method of displaying indicia on the outside surface of a vehicle door, comprising the following steps:
a. installing a device with a planar member and an integrally formed an edge member configured to engage the trailing edge of a vehicle door, with at least one magnetic element attached to the planar member and magnetically holds the planar member on an outside surface of a vehicle door when the edge member is attached to the trailing edge, said planar member includes an outside surface with indicia printed or formed thereon;
b. selecting a door with an exposed door edge to attach said holder;
c. aligning said device so that said indicia faces outward and visible; and,
d. attaching said edge member to said door edge and position said magnetic element against the outside surface of the door.
